(19) United States
(12) Patent Application Publication
(10) Pub. No.: US 2014/0324947 A1
(43) Pub. Date: Oct. 30, 2014

(54) METHOD AND SYSTEM FOR DIGITALLY CLIPPING AND TRANSFERRING CONTENT

(71) Applicants: Michael T. McKay, Maple (CA); Jennifer C. McKay, Maple (CA)

(72) Inventors: Michael T. McKay, Maple (CA); Jennifer C. McKay, Maple (CA)

(21) Appl. No.: 14/212,575

(22) Filed: Mar. 14, 2014

Related U.S. Application Data
(60) Provisional application No. 61/794,072, filed on Mar. 15, 2013.

(51) Int. Cl. H04L 29/06

(52) U.S. Cl. CPC H04L 65/60
USPC 709/203

(57) ABSTRACT

Techniques for identifying and transferring digital content between digital devices are disclosed. Methods and systems for digitally clipping and transferring content are disclosed.

### CROSS-REFERENCE TO RELATED APPLICATION

This application claims the benefit of U.S. Provisional Patent Application No. 61/794,072, filed on Mar. 15, 2013 and entitled METHOD AND SYSTEM FOR DIGITALLY CLIPPING AND TRANSFERRING CONTENT, which is incorporated herein by reference in its entirety.

### TECHNICAL FIELD

This disclosure relates to digital communication. Techniques for identifying and transferring digital content between digital devices are disclosed. Techniques for digitally clipping and transferring content are disclosed.

### BACKGROUND

Mobile computing devices or mobile devices, such as smart phones and tablets, allow people to access and consume content in a variety of ways. Generally, mobile devices are connected to the Internet via a wireless communications network, such as a cellular network or WI-FI™. Many mobile devices are generally carried with a person at all times.

These mobile devices provide the user with a variety of applications or apps. These applications for mobile devices are generally computer software programs designed to be used specifically on a mobile device. These applications may allow the user to access the Internet via a web browser, download applications via a distribution network, take and store photos, listen to and play music, make telephone calls, and consume content on an on-demand basis in a variety of locations.

Mobile devices also allow users to keep track of a variety of things in a variety of ways. For example, a user can record or take note of something they want to remember or use at a future date by, for example, email, photographs, specialized productivity applications, or a notes tool. When accessing content through a web browser, web page locations are stored by using a bookmark. The bookmark can be used to retrieve the web page at a later date. Usually, connecting to content via a web browser on a mobile device is only available when there is an active network connection to the Internet.

Social bookmarking allows for users with similar interests to share bookmarks with each other, or to store their bookmarks on the Internet for access from other computing devices or web browsers. The stored bookmarks are generally only available to a mobile device with a network connection to the Internet.

Many content publishers have created mobile device applications to deliver their content to users. Access to content while off line, that is without a network connection, is subject to the functionality of the application. Some applications provide access to data off line by storing or caching a local copy, while others applications require connectivity to access any data.

Presently, content is generally delivered to the user in a uni-directional manner. That is, a user opens a content publishers' website or application, reads content published by the publisher, and may save the content or a link to the content for reading later by bookmarking the page, marking it as a favourite; or copying and pasting the content or the link into another vehicle such as an email, note, organizational application; or share the content or the link, via any of the number of social media web sites or applications for sharing content.

### SUMMARY

In one general aspect, a system for digitally clipping and transferring content includes a user application running on a computing device for submitting a clipping code to a server and receiving a clipping; a clipping creator program for creating the clipping and transferring the clipping to the server; and the server for performing analytics, processing commands for creating and storing the clipping and the clipping code, and transferring the clipping.

In another general aspect, a method for digitally clipping and transferring content includes creating a clipping and transferring the clipping to a server; running a user application on a computing device for submitting a clipping code to the server and receiving the clipping; and enabling the server to perform analytics, process commands for creating and storing the clipping and the clipping code, and transferring the clipping.

In another general aspect, a method for a user device is provided. The method includes accepting a clipping code associated with a content, requesting from a server a clipping associated with the clipping code, receiving the clipping from the server, and displaying the clipping once the clipping is received from the server. In this aspect, the clipping may include a pre-generated clipping content and a context integration data associated with the clipping.

In another general aspect, a method for a server is provided. The method includes accepting a clipping code from a user device, retrieving a clipping associated with the clipping code, and transmitting the clipping to the user device. In this aspect, the clipping may include a pre-generated clipping content and a context integration data associated with the clipping.

In another general aspect, a system for digitally clipping a content is provided. The system includes a user device configured to accept a clipping code, transmit the clipping code to a server, and receive a clipping from the server. The system further includes a server communicatively connected to the user device, the server configured to accept the clipping code from the user device, retrieve the clipping associated with the clipping code, and transmit the clipping associated with the clipping code to the user device.

In another general aspect, a user device is provided. The user device includes an input device configured to accept input, a memory device having executable code, a network communications device configured to communicate with a communications network, a display device, and a processor device being coupled to the input device, the network communications device, the display device, and to the memory device. The processor device is configured to execute the executable code stored in the memory device. The executable code is configured to direct the processor device to accept a clipping code associated with a content, request from a server a clipping associated with the clipping code, receive the clipping from the server, and display the clipping on the display device once the clipping is received from the server, and the clipping including: a pre-generated clipping content, and a context integration data associated with the clipping.

In another general aspect, a server is provided. The server includes a network communications device configured to communicate with a communications network, a memory device having executable code, and a processor device being coupled to the network communications device and to the memory device. The processor device is configured to execute the executable code stored in the memory device. The executable code is configured to direct the processor device to accept a clipping code from a user device, retrieve a clipping associated with the clipping code, and transmit the clipping to the user device, and the clipping including: a pre-generated clipping content, and a context integration data associated with the clipping.

In another general aspect a clipping creator is provided. The clipping creator includes a network communications device configured to communicate with a communications network, an input device configured to accept input, a memory device having executable code, and a processor device being coupled to the input device, the network communications device, and to the memory device. The processor is configured to execute the executable code stored in the memory device. The executable code is configured to direct the processor to generate the clipping from the content, associate the clipping code with the clipping, transfer the clipping and the associated clipping code to the server, and to include a context integration data in the clipping.

Implementations can include one or more of the following features. Publisher created and branded content to the user's computing device via a communications network, so the system and method can digitally clip printed content and online content.

Implementations can include providing a system and method for editing, creating and delivering, a digital clipping of an article or other content found in print, online, mobile, TV, packaging, outdoor or other places to a computing device.

Implementations can include providing a method and system allowing a user to request, transfer and store content from any participating publisher or content owner in an application that may run on a computing device, including a mobile computing device, thereby eliminating the requirement to remember where the user read said content and then find a related bookmark or favorite through a browser or other mobile app.

Implementations can include providing a method and system to connect printed content to digital applications and to provide publishers and advertisers with more data.

Implementations can include providing context aware integration allowing for two way communication or interactive exchange between the owner of the content and the user, or between the content and the user, beyond that initial impression.

The disclosed techniques may allow the publisher's branding and content to be perpetuated or used by a user, instead of being trashed or deleted. Additionally, the techniques can provide context integration that transforms what information is useful, to why that information is useful to the particular user. With the data that can be tracked or logged or generated from the disclosed method and system, publishers can define their content management system to provide better and more useful content or information to users in order to promote their brand as providers of information. Also, advertisers may have a clearer picture of the return on investment (ROI) for media buys based on the data from the method or system disclosed herein, which may be useful for making future decisions affecting marketing and advertising.

Implementations of the techniques described above can include a method, a process, a device, executable instructions stored on a computer readable medium, or an apparatus. The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an exemplary system.

FIG. 2(a)-2(j) are examples of the graphical user interface.

FIG. 3A-3M are examples of database tables and query results.

FIG. 3A illustrates an example table for a digital clipping, the table name is Qlips and shown are the fields that comprise the table;

FIG. 3B(i)-(iii) illustrates an example query result for the Qlips database;

FIG. 3C illustrates an example table for an advertisement, the table name is Ad and shown are the fields that comprise the table;

FIG. 3D illustrates an example query result for the Ad database;

FIG. 3E illustrates an example table for a user profile, the table name is Profile and shown are the fields that comprise the table;

FIG. 3F illustrates an example query result for the Profile database;

FIG. 3G illustrates an example table for a publisher profile, the table name is Publisher and shown are the fields that comprise the table;

FIG. 3H illustrates an example query result for the Publisher database;

FIG. 3I illustrates an example table for a clipping request log, the table name is QlipsLog and shown are the fields that comprise the table;

FIG. 3J illustrates an example query result for the QlipsLog database;

FIG. 3K illustrates an example table for details of a clipping request that has been logged, the table name is QlipsLogLink and shown are the fields that comprise the table;

FIG. 3L illustrates an example query result for the QlipsLogLink database; and

FIG. 3M illustrates an example table for a clipping sharing log, the table name is QlipsLogShare and shown are the fields that comprise the table.

### DESCRIPTION

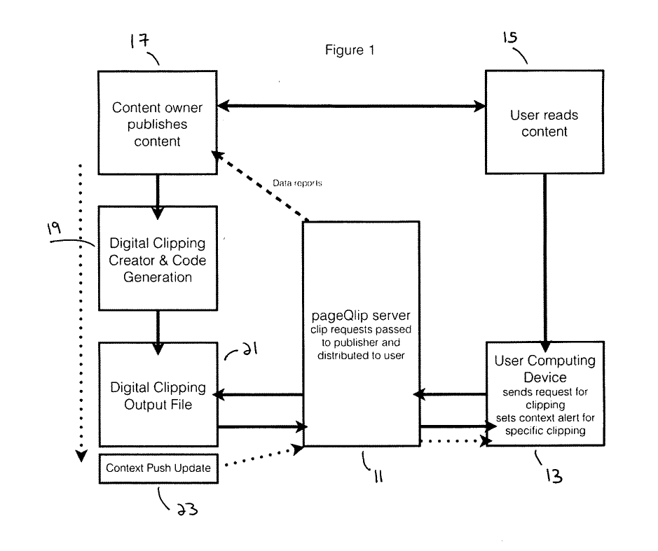

Referring now to FIG. 1, an example of the system and method is shown. A server 11 communicates with a user's computing device 13 and a digital clipping creator 19. A content owner may publish content 17, using the digital clipping creator 19 to create a digital clipping 21 that is transferred to the server 11, the clipping may include a context integration 23. A user 15 may use their computing device 13 to request a clipping from the server 11.

### Digital Clipping

In an implementation, a digital clipping or clipping, is similar to the digital version of taking a pair of scissors to a print article so you can use or share the information later. The clipping may contain a branded synopsis of key information from any content that is published in print or digital media, with a link to full content, downloadable to a computing device upon request. The author or publisher of the article's content determines the content of the clipping or synopsis. The content could also be digital version of a print, mobile or online advertisement or any specific content curated to provide information, such as information on retail packaging or labels. Generally, the clipping and the content of the clipping are analogous. A skilled person would understand that generally there is no limitation as to the information that may comprise the clipping or content of a clipping.

Additionally, in another implementation, the clipping may also contain various kinds of data associated with the content, such as meta-data or context integrations, which will be described in detail below.

### Digital Clipping Creator

In an implementation, a digital clipping is created with a digital clipping creator program or clipping creator program whereby the customer or publisher will summarize the key points and information about the content that the reader may find useful, for example, titles, authors, product references, web links, locations, addresses, pricing, time events, calendar events, related links, and descriptions to support the information.

The clipping creator program for creating a digital clipping allows the publisher to populate designated fields through a user interface of the clipping creator program by direct entry or cut and paste or automated methods. These fields allow for the content of the clipping to be delivered to the user in a readable and visual format, within the user application on the user's computing device, and provide contextual interactions, as well tracking and data tags that allow the customer to track and manage certain data points. The clipping is a digital file residing with the publisher, on the sever, or at the location of the publishers' choice, as it is their content to manage and remain responsible for, which may reduce copyright infringement concerns among others.

The clipping creator program may provide for embedding of the content publisher's chosen branding image within a clipping, and also may provide for the optional embedding of a uniquely targeted mobile ad, thereby providing monetization opportunities for publishers. In another implementation, it is possible to provide specific customer application programming interface (API) integration for direct product or reference search.

For example, in one implementation, a print publisher has a review of a cycling trip in a wine region in their weekly column on wine or travel. The clipping is created using the clipping creator program with the publishers' branding image, the author, date of original publication and allows for an image, which may be associated with the original article, to be uploaded to the clipping server. The title used by the clipping creator program most likely matches the original article, or it may be altered. The original text of the review is curated to identify the key article points, and may integrate specific hyperlinks from the original article for user interactions, for example those hyperlinks may link to websites for booking accommodations, or airline transport, or there may be a map integration to link to as well.

Additionally, the publisher may use the clipping creator program to include in the clipping additional information such as a specific time and date for an event that can be further associated with a time/calendar context alert that the user can manipulate. The clipping may also provide a link to a digital version of the original article located on a website or mobile website, or contact information such as an e-mail address, or a phone number, or geolocation information, or data subject tags can be entered (e.g. travel, finance, wine, cars, books) to allow for data cross-referencing for subject tracking, internal search mechanisms, advertising cross-reference (e.g. banner ads) or popularity/trending within a social or subject graph, or context integration.

### Clipping Code

In an implementation, once the clipping has been created it will be assigned a clipping code that may be associated with a designated portfolio or column or subject for a publisher's account, and which identifies the specific clipping and where it may be published (i.e. geo-demographics). The clipping code can be generated manually, or automatically using an algorithm. If the code is generated automatically, the clipping code may be generated by the server or clipping creator. The clipping code may be preferably optimized for human readability, e.g. like a uniform resource locator (URL) or email address, and it may have requirements for uniqueness in order to specifically identify a clipping.

The clipping code, may be in one implementation, a specific alpha numeric code that is published in the print edition, along with an icon for identifying the clipping code to a user, in much the same manner as the author's e-mail, phone number, or brief biography might appear at the end of an article. The publisher will include this clipping code into their print edition as part of their workflow process. In alternate implementations, the clipping code may be a machine readable code such as a QR code.

For example, in some implementations, a print publisher or advertiser may run the same content in five regional editions and desires to have a different clipping code for the same piece of content so that they can track the popularity of the content by geographic or distribution channel (e.g. west coast edition vs. east coast edition). There is no limitation that the content be specifically print or online. The reader, also using an implementation of the disclosed techniques, who has enjoyed the content or article and finds it useful, will see the identifying icon and clipping code as part of the content or article. The reader would launch the user application on their computing device, which may be a mobile device, and enter the clipping code from the content or article into the user application either manually, or use a means for automatically entering the clipping code into the user application. One implementation of the means for automatically entering the clipping code may be the use of optical character recognition (OCR). If the computing device has an active internet connection, the user application may attempt to retrieve the clipping immediately to the mobile device by sending the clipping code to the server for processing. The user application may allow the user to enter and batch requests for clippings while reading in an environment where the computing device has no network connectivity, e.g. on an airplane, and then have the user application send out the requests for clippings to the server upon connection to the Internet.

### Server

In an implementation, the server contains in databases information such as, the user account and profile, the requesting computing device's operating system (OS). Additionally, all the user data may be de-personalized, secured, encrypted or a combination of the previous steps. A skilled person would understand that the database may be searchable and that requests for searching may be submitted remotely from other computing devices.

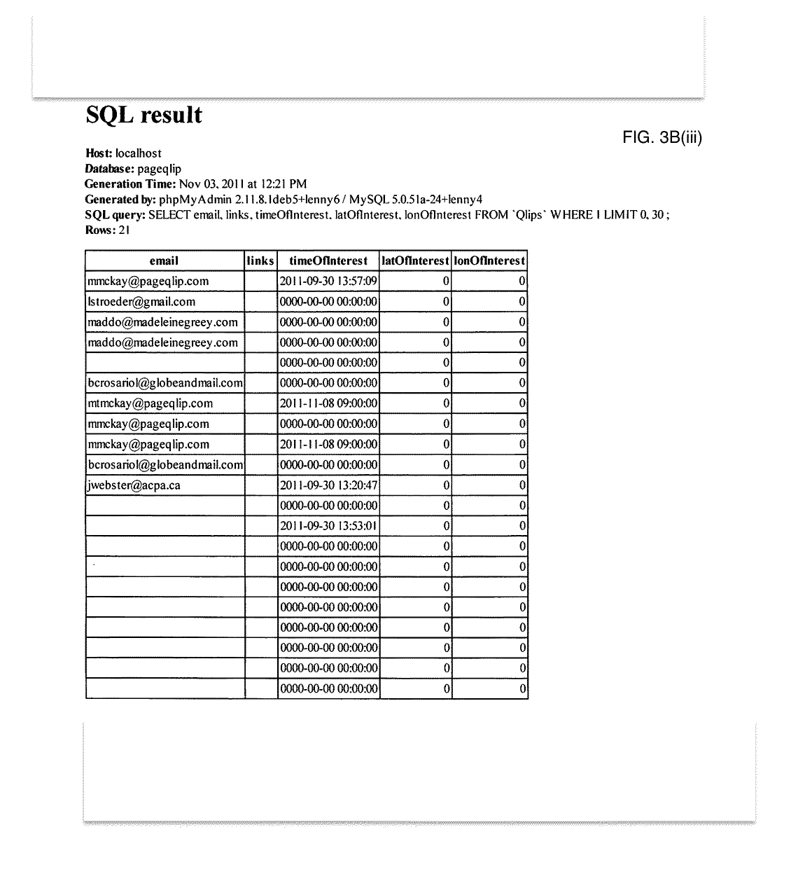

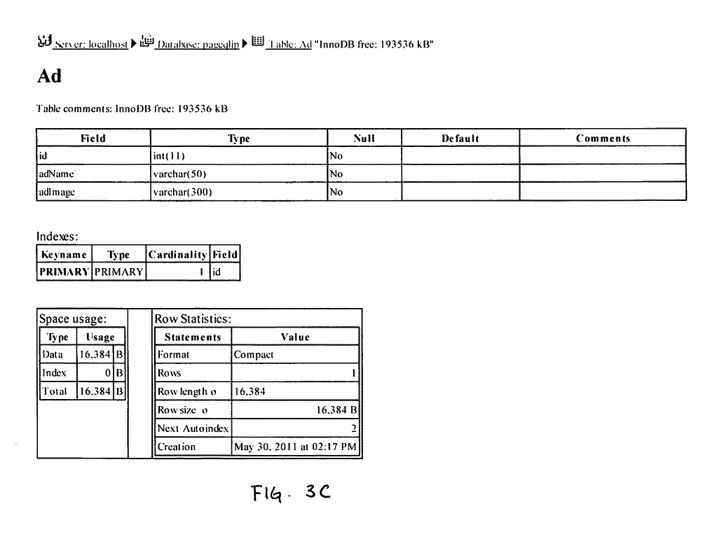

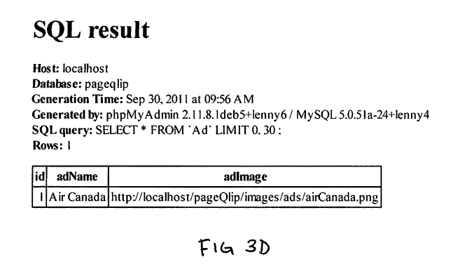

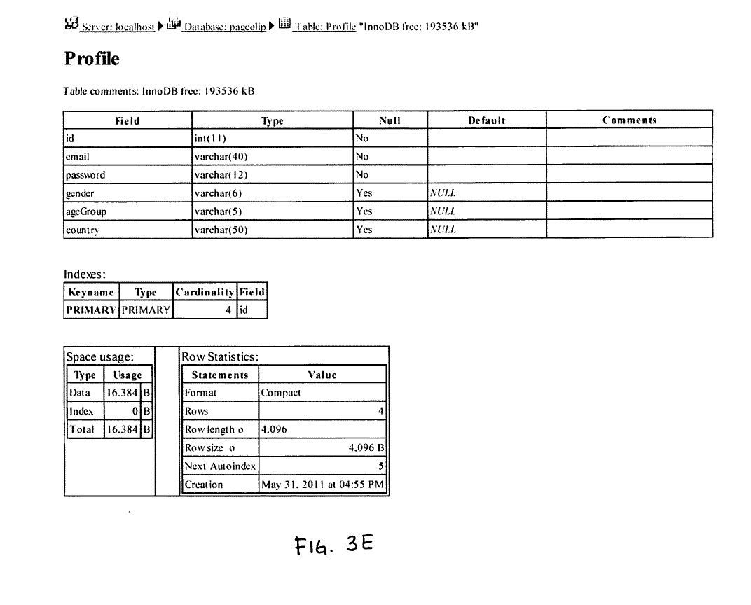

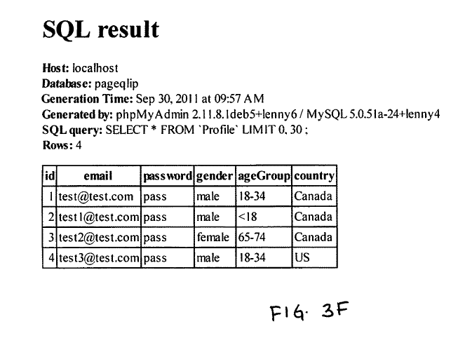

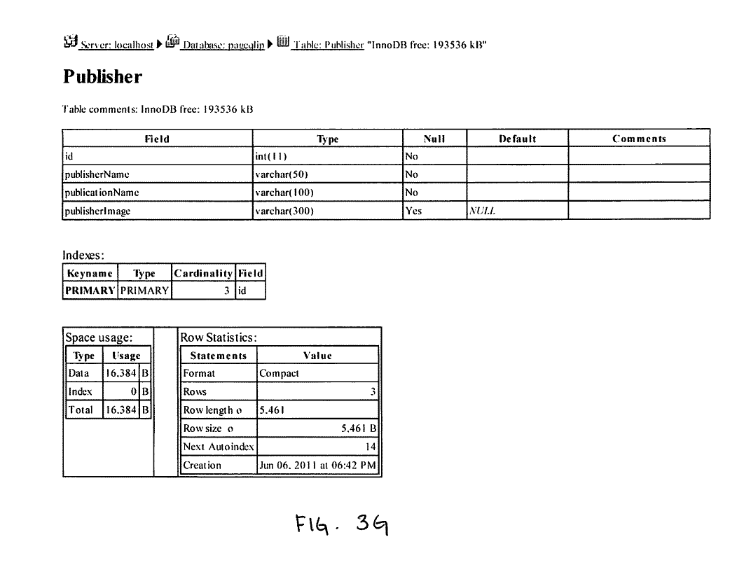

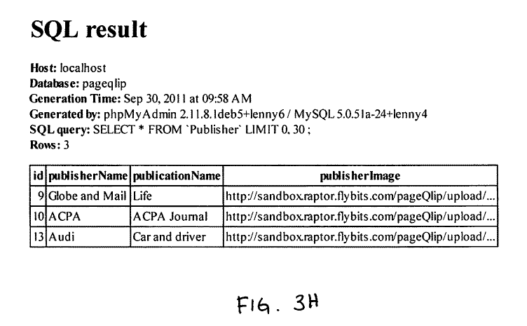

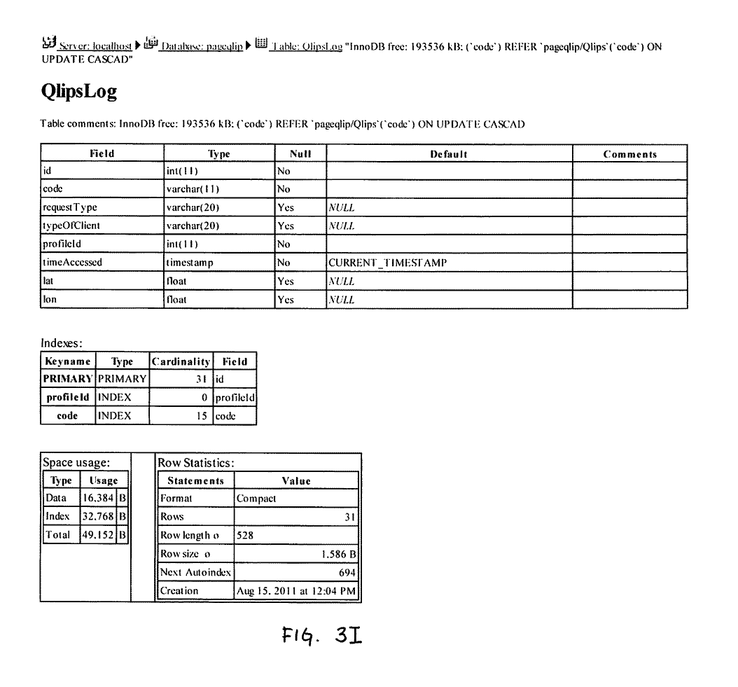

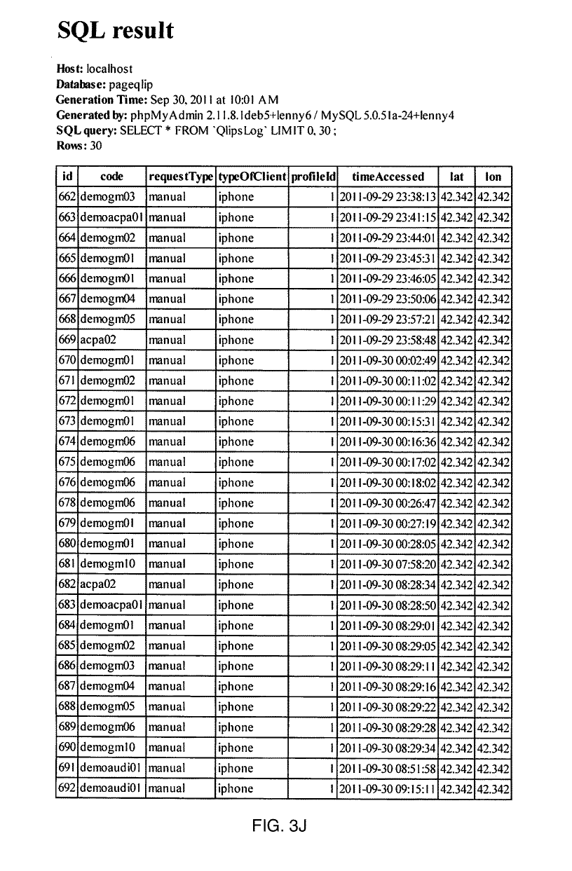

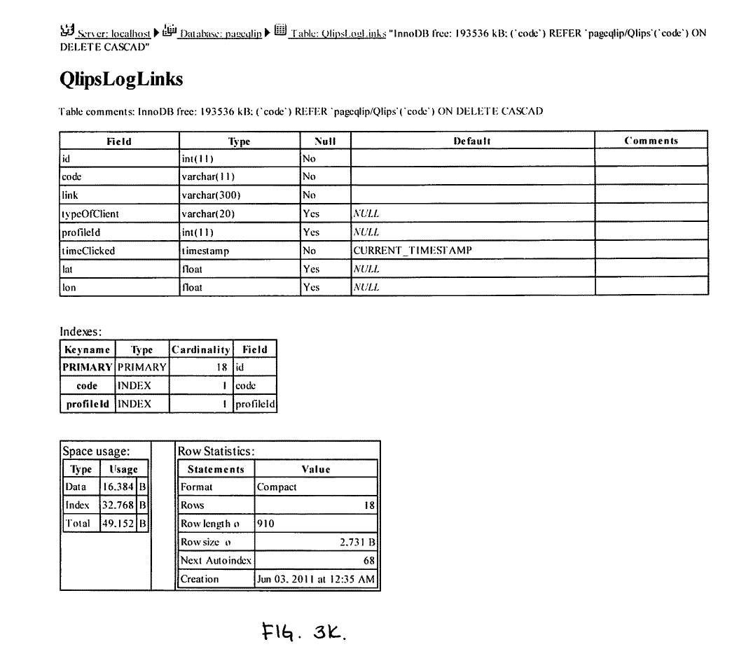

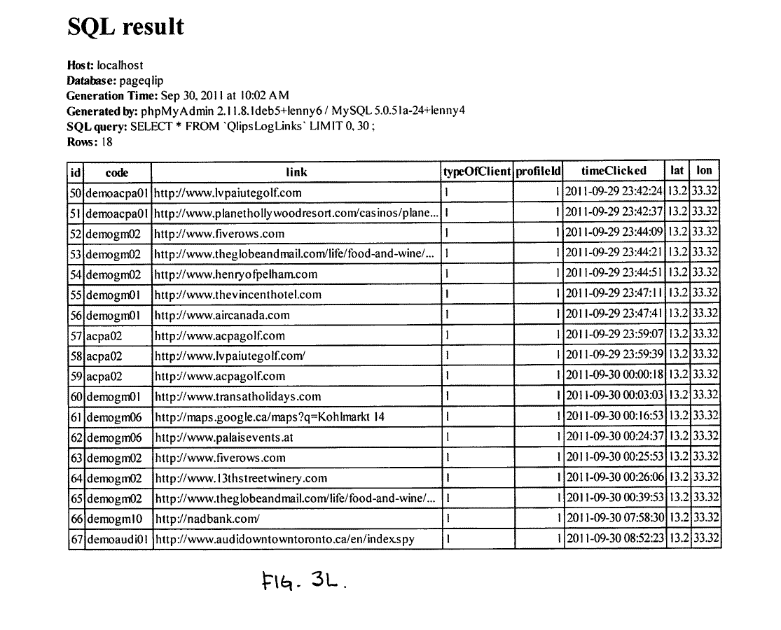

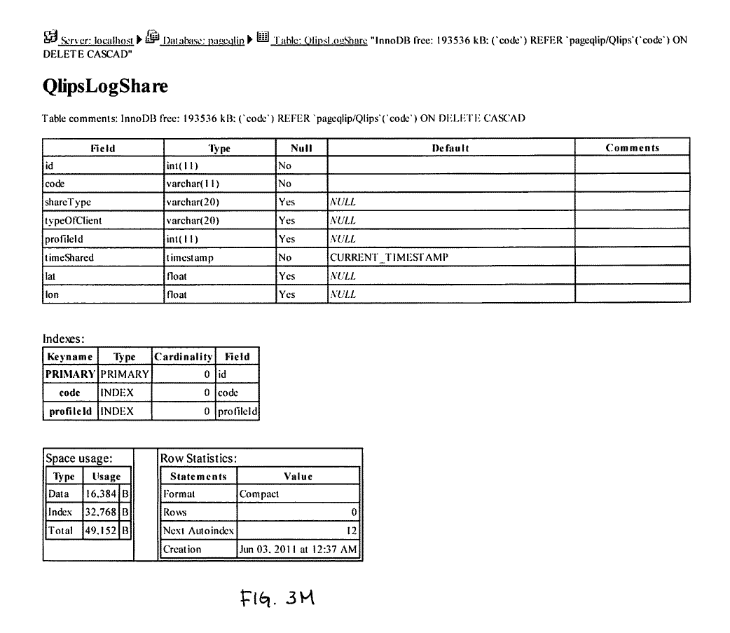

The database may, in one implementation, use a relational database. Referring now to FIGS. 3A to 3M, a skilled person would understand that what is shown are database tables and SQL query results showing example results from a query of a database for those tables, which may be used in an implementation. A skilled person would understand that the tables illustrated describe the required fields, types for the fields, whether a null value is allowed for the field, the default value of the field, and any additional comments. Also shown are indexes such as the primary key for the table.

The server will direct requests for clippings to the appropriate content publisher's servers or wherever the clipping is determined to be held in order to retrieve the file representing the clipping, and the file is transmitted to the server, where the server may perform data analytics and billing. The server then sends the clipping to the user application running on the user's mobile device. The user application may in some implementations display information that indicates to the user that a new clipping has been retrieved.

The server may perform data tracking or data analysis of the requests for clippings, clipping codes, clippings, or other data that the server has access to. Preferably, the data, and results of the data tracking and data analysis resides only within the server. Customer, that is publisher or advertiser, specific data reports may be generated and made available or accessible to each customer as required.

The server may format the clippings so that they can be processed by the user application running on any computing device with a supported operating system. Additionally, the server will format the clippings so that they can be shared among different user applications running on computing devices with supported operating systems.

The clippings may be shared by sharing the clipping code, which a skilled person would understand as functioning similar to a URL, alternatively, the actual contents of the clipping may be shared or transferred to the computing device, or both the clipping code and the content of the clipping could be shared or transferred. Generally, the sharing of the content of the clipping may occur between a user application on a computing device and the server. Transferring just the clipping code is data efficient, but transferring just the clipping code does not include transferring the contents of the clipping.

### User Application

In some implementations, the user application provides the user with a graphical user interface (GUI) for interacting with the clipping system, such as entering clipping codes to retrieve the contents of a clipping from the server, and other actions that a user may want to perform. Examples of such actions are described below along with an illustrative example of the GUI.

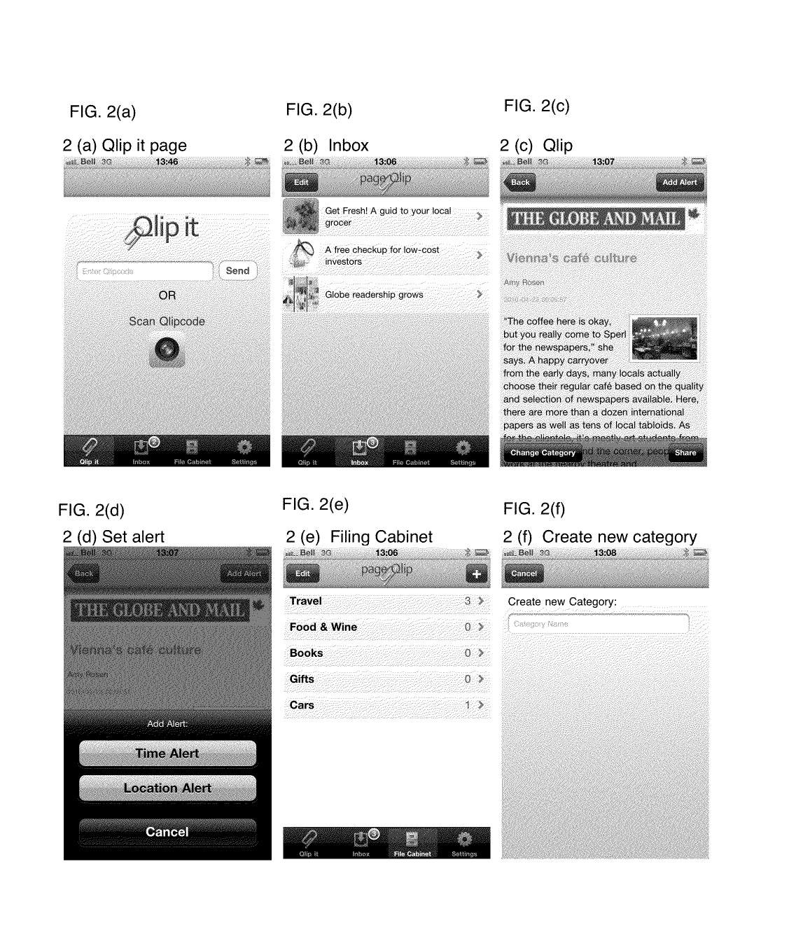

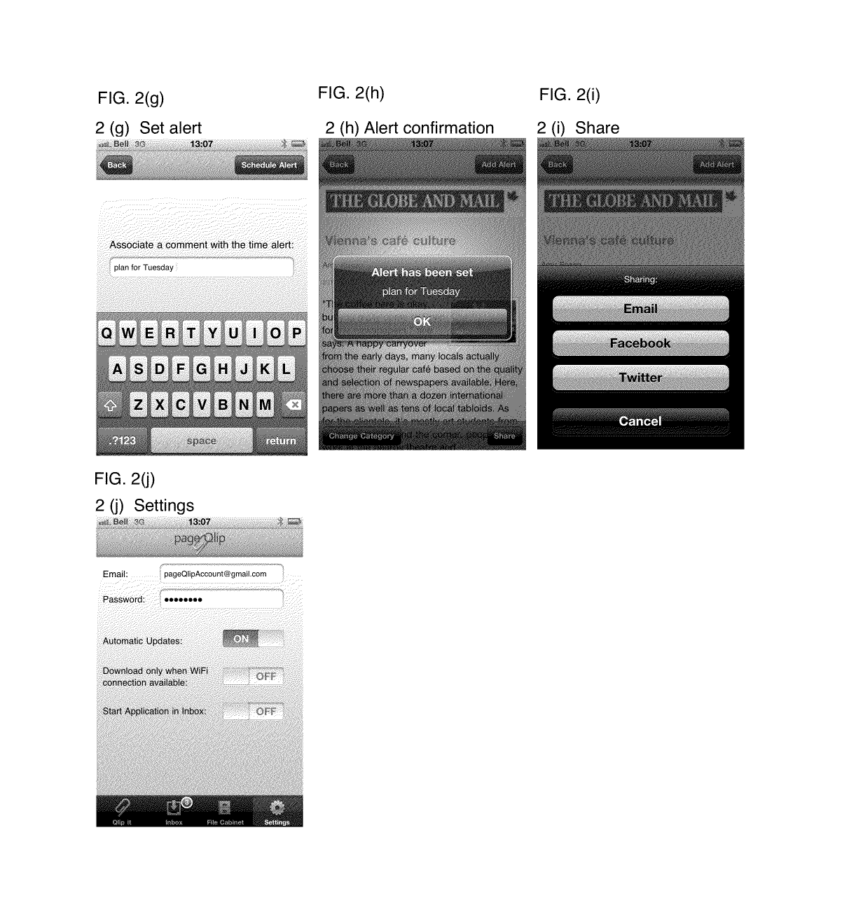

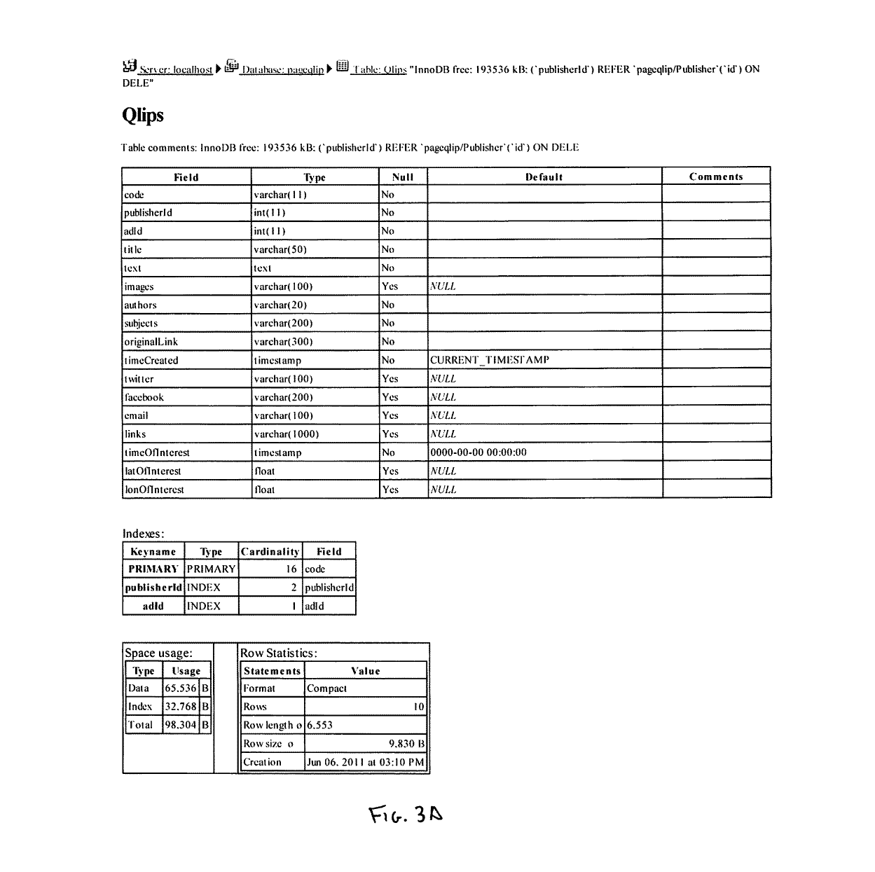

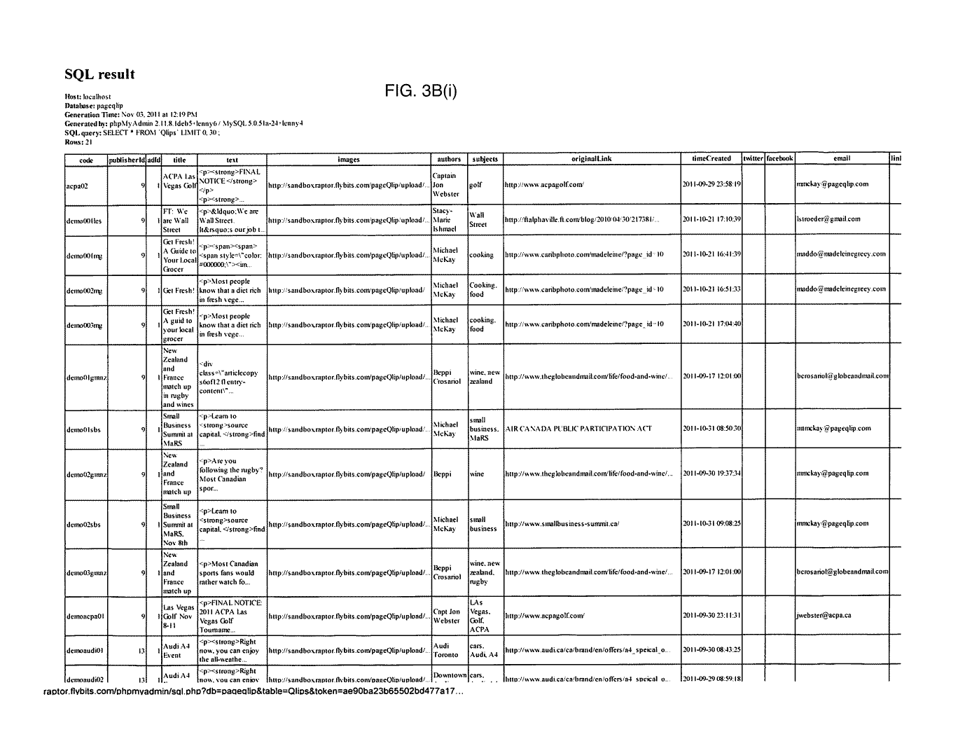

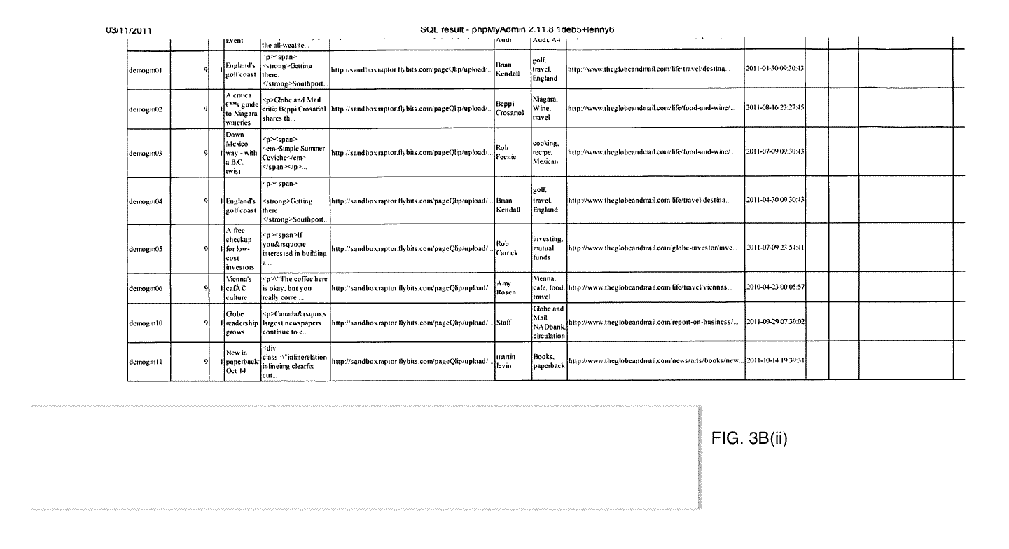

Referring now to FIGS. 2(a)-2(j), screenshots of one implementation of the GUI for the user application for a computing device are shown.

FIG. 2(a) illustrates an example of the QLIP IT™ page, where a user may enter a clipping code or select an icon to scan the clipping code using, for example, optical character recognition and may also include a menu bar with various icons that can be selected to view different GUI pages in the user application.

FIG. 2(b) illustrates an example of an inbox where newly transferred clippings can be stored.

FIG. 2(c) illustrates an example of a clipping viewing page, where the contents of a clipping are displayed for viewing.

FIG. 2(d) illustrates an example of a set alert page, where the user may set a time based alert or location based alert for the clipping shown greyed out in the background.

FIG. 2(e) illustrates an example of a filing cabinet page, where the user may store and organize clippings that have been transferred. The categorization of the clippings may happen automatically or manually.

FIG. 2(f) illustrates an example of a create new category page, where the user may create a new category for use in organizing clippings that have been transferred.

FIG. 2(g) illustrates an example of a set alert page page, where the user can schedule the alert and enter comments associated with the alert, the alert being associated with a clipping.

FIG. 2(h) illustrates an example alert confirmation page, where the user receives confirmation that the alert for the clipping has been set.

FIG. 2(i) illustrates an example clipping sharing page, where the user may share a clipping by email, facebook, or twitter.

FIG. 2(j) illustrates an example settings page, where the user may enter their email and password for logging on to the clipping system, select whether they want automatic updates to the user application, select whether they want downloads to occur only when WiFi connections are available, and select whether they want the user application to start on the inbox page.

The user may at their convenience launch the user application where the clipping may be retrieved, transferred, viewed, categorized, left in the inbox, searched, set an alert, or perform other actions as may be allowed by the user application. In an implementation, the clipping may be shared via several methods such as e-mail, twitter, facebook, or other desired methods.

Alternatively, a skilled person would understand that the user application may be a website running in a web browser that performs substantially the same functions as described above.

### Context Integration

In an implementation, the user application may provide several context integrations or context interactions that may be defined by the user or the content publisher or both. A context integration is analogous to an action that may be performed in association with a clipping. A date or time or both related alert with a clipping is one type of context integration. Also, a location or geo-location based alert related with a clipping is another type of context integration. Entering a comment to be associated with a clipping may also be a type of context integration.

For example, the user may allow alerts that cause push notifications to be generated from the user application when the clipping provides information on when such an alert might apply (e.g. three days left until event), or the user can set their own preference in the user application for a local alert based on the location associated with the clipping for a geo-location type of alert, or the user may simply add comments. Alternatively, the alerts associated with a clipping may be set by the creator of the clipping, then the user may be able to control whether they want to receive the automatically generated alerts through the user application.

These user defined alerts and comments may be local to the user application or computing device, and may or may not be tracked by the server. Alternatively, alerts set by the creator of the clipping will probably intend for the server to track and monitor the alerts.

A clipping may also be tracked based on its popularity, how often it is repeated or shared, or based on a social graph. This tracking by the server may be facilitated by the clipping creator or server allowing for the creation of tags related to the clipping. It may be an option for the user to select in order to allow, i.e. opt-in, for transferring of clippings or notifications from clippings based on, for example, popularity.

### System

In one implementation, a system includes:
a user application comprising a user interface accessed through the user's computing device for submitting a clipping code to a server;
a clipping creator program for creating the clipping and transferring the clipping to the server; and
the server for performing analytics and processing commands for creating and transferring clippings.

In another implementation, the system includes:
a user application running on a computing device for submitting a clipping code to a server;
the server for performing analytics and transferring the clipping associated with the clipping code to the user application.

In another implementation, the system includes:
a clipping creator program for creating a clipping and transferring the clipping to the server;
the server for performing analytics, receiving the clipping and assigning a clipping code to the clipping.

In another implementation, the system includes:
a user application running on a computing device for submitting a clipping code to a server and receiving a clipping;
a clipping creator program for creating the clipping, transferring the clipping to the server, and providing context integration for the clipping; and
the server for performing analytics and processing commands for creating and storing the clipping and the clipping code, transferring the clipping to a user application, and providing context integration for the clipping.

### Method

In an implementation of a method aspect of the disclosed techniques, in order to access clippings on a computing device, the user will be required to download the user application to their computing device. The user application will be transferable through the distribution networks available to the computing device, e.g. ITUNES™ for mobile computing device such as the IPHONE™, or a website for other computing devices.

The user may create an account located on the server upon initial set up of the user application. Basic information (user id/email address and password) about the user may be required, e.g. user identification/email address and password, with optional additional information to allow for better context integration and bi-directional interaction with the system. The user may also set preferences for receiving content through communication networks such as WIFI or cellular networks.

The user may request a digital clipping from a participating publisher, advertiser or content owner in one of several ways:

For one implementation of a method to request a digital clipping using a computing device, the user may access the user application. Then the user will enter the clipping code or content's unique identifier that is published and placed near the content either, manually using the computing device's available input devices, or automatically, for example, by scanning the clipping code with the computing device's camera and then using optical character recognition (OCR) technology to extract the clipping code from the image.

Alternatively in another implementation, a user could be using a computing device such as a desktop, a laptop, or mobile computing device to read online articles, web or mobile-based advertisements, or other digital content. If the digital content has a clipping code available, a small icon may reside near the digital content, which will be actionable. The user may click on the icon representing the clipping code to request the clipping. The user will be asked for the user's id of the system or server account to which the content should be transferred, this information could optionally be mapped by the server via a cookie, such that future requests from the same user client or user application, do not need to have this additional step and may be a single click action to request and download the clipping. The clipping will then be transferred to the user's computing device.

In another implementation, the request for a clipping or sending a clipping code, may be sent to the server or owner of the content at a user defined point in time, for example defined by preference settings in the user application such as immediately using any network connection or WIFI only. The request including a clipping code may pass through the server and be redirected to the applicable owner of the clipping's content's server system or only to the server. The contents of the clipping may then be transferred to the user from the owner of the clipping's content's server system and through the server, or the server may transfer the contents of the clipping.

Certain data elements may be stored on or gathered by the server system related to each clipping or clipping code request. The data may be anonymized for sharing per a company's privacy policy, except when given permission by the user to share certain data elements or aggregations of data elements or results of data analytics. The types of anonymized data that may be shared with customers include but are not limited to: how many times a clipping has been downloaded, shared and by which method or methods and from which type of computing device. Other data may be edition, publication date, or the website from where the clipping or clipping code was requested.

A clipping may have data subject tags (for example, travel, finance, wine, cars, books) to allow for data cross-reference for subject tracking, internal search mechanisms, advertising cross-reference (banner ads) or popularity/trending within a social or subject graph. It may also allow for “smarter” contextual integration.

The clipping may then be received at a user defined point in time (immediately using any network connection, or WIFI only) on the computing device in the user applications inbox. The clipping may be highlighted until reviewed and can then be filed under a user defined category for easy location in the future. The user may also have the ability to share the clipping via social media networks including, but not limited to facebook and Twitter, or via email.

The user may be able to interact with the content in a user defined context integration as well as opt-in from content defined context integration. The user may define certain context alerts, such as (but not limited to) date, time, location. The user may also opt-in to interact with content defined context alerts such as but not limited to content updates, time alerts, geo-location actions, or offerings from the publisher/advertiser.

The content residing in the user application on the computing device will be available at any time, even when the computing device is not connected to a network or the Internet. Additionally, the user may be able to create and batch requests for clippings while offline, in “airplane mode” for example, and have the requests for clippings comprising clipping codes sent once reconnected to the appropriate network.

In another implementation, a publisher or advertiser may create the clipping of their content using the clipping creator software application. This clipping creator content tool may allow publishers to edit their content for the clipping, comprising typically a synopsis of an article with a link to a full article, an associated image, and any related information or links such as but not limited to, contact information (e.g. phone or e-mail, or website), location or maps, and calendar/time information. The clipping will also provide for the publishers' logo or masthead within the clipping. Additionally for publishers, they will have the ability to embed a mobile-style ad within the clipping. The clipping may reside on the publishers' server and be sent to the user upon request via the server system, or they may reside on the server after being uploaded by the creator of the clipping either manually or with the clipping creator application.

Advertisers, including but not limited to print, on-line, mobile banner, billboard, may have the ability to use an ad that has a clipping or clipping code as the image with additional space for more content related to the ad. This could be in the form of an offer or expiry date for example. A “shop now” button could be included, rather than the “link back to full article” component of the publishers' version.

Both publishers and advertisers may have the ability to ‘tag’ the clipping for context related items, such as key dates, times, and locations. Users may then have the ability to opt in and have contextual interactions or alerts related to those key components provided to them if they choose.

The clipping itself may be in or the server may provide for a clipping format that can be transferred and accessed on many computing devices or computing platforms.

Each clipping has a clipping code. Additionally, the same clipping could have different clipping codes assigned to it depending on when and where the content may appear. This may allow a customer such as a publisher or advertiser to identify which edition or region that particular article was from, based on the clipping code for the clipping, for an article or ad that is running across multiple editions, publications, or distribution platforms.

### Alternative Implementations

### Online

While the above description explains the implementations of the method aspects of the disclosed techniques principally within the context of print media via the clipping code being manually or automatically entered, another implementation of the method aspect translates to online digital publishing as well, through a clickable icon or action widget or ‘share this’ type of method for submitting the clipping code to the server.

Depending on the computing device, e.g. desktop or mobile, the clickable action may take you to an account page, with username and password mechanisms to confirms identity and send the request for the clipping. The login information or username and password may be cached or remembered as explained above. The method follows a similar set of steps via the server and the contents of the clipping is sent to the computing device.

### Software as a Service

Another implementation includes the development of a software as a service (SaaS) platform using the above described system or systems. The system may be have the ability to be offered under a “white label” platform such that a customer with a specific audience could use the platform to provide a solution for providing clippings within their company's published content vehicles directed to a defined user group, such as, employees, for example.

The following clauses are offered as further description. Any one or more of the following clauses may stand on its own merit without having to be combined with another other of the clauses. Clause (1) a method of any clause mentioned in this paragraph, the method for a user device comprising accepting a clipping code associated with a content, requesting from a server a clipping associated with the clipping code, receiving the clipping from the server, and displaying the clipping once the clipping is received from the server. The clipping including a pre-generated clipping content, and a context integration data associated with the clipping. Clause (2) a method of any clause mentioned in this paragraph, further comprising adding the context integration data to the clipping. Clause (3) a method of any clause mentioned in this paragraph, further comprising using the context integration data in the clipping. Clause (4) the method of any clause mentioned in this paragraph, the method for a server comprising accepting a clipping code from a user device, retrieving a clipping associated with the clipping code, and transmitting the clipping to the user device; the clipping including a pre-generated clipping content and a context integration data associated with the clipping. Clause (5) a method of any clause mentioned in this paragraph further comprising tracking the context integration data associated with the clipping. Clause (6) a method of any clause mentioned in this paragraph, the method further comprising analyzing the context integration data associated with the clipping. Clause (7) a method of any clause mentioned in this paragraph, further comprising generating, using a clipping creator, the clipping, the clipping content, and the clipping code; and transferring, from the clipping creator to the server, the clipping, the clipping content, and the clipping code so that the clipping can be retrieved by the server using the clipping code. Clause (8) a method of any clause mentioned in this paragraph, the step of generating further comprising including the context integration data in the clipping. Clause (9) a method of any clause mentioned in this paragraph, wherein the clipping content includes the content. Clause (10) a system of any clause mentioned in this paragraph, the system for digitally clipping a content comprising a user device configured to accept a clipping code, transmit the clipping code to a server, and receive a clipping from the server; and the server communicatively connected to the user device, the server configured to accept the clipping code from the user device, retrieve the clipping associated with the clipping code, and transmit the clipping associated with the clipping code to the user device. Clause (11) a system of any clause mentioned in this paragraph, the server further configured to track a context integration data associated with the clipping, and to store the tracked context integration data. Clause (12) a system of any clause mentioned in this paragraph, the server further configured to analyze the tracked context integration data. Clause (13) a system of any clause mentioned in this paragraph, the user device further configured to add the context integration data to the clipping. Clause (14) a system of any clause mentioned in this paragraph, the user device further configured to use the context integration data in the clipping. Clause (15) a system of any clause mentioned in this paragraph further comprising a clipping creator configured to generate the clipping from the content, associate the clipping code with the clipping, and to transfer the clipping and the associated clipping code to the server. Clause (16) the system of any clause mentioned in this paragraph, the clipping creator further configured to include a context integration data in the clipping. Clause (17) a system of any clause mentioned in this paragraph, wherein the clipping creator is integrated with the server. Clause (18) a system of any clause mentioned in this paragraph, wherein the user device is any one of a computer, a mobile device, a computing device, a web browser, or a web browser extension. Clause (19) a system of any clause mentioned in this paragraph, wherein the server includes a data store for storing at least the clipping, the clipping code associated with the clipping, and a context integration data associated with the clipping. Clause (20) a system of any clause mentioned in this paragraph, wherein the server and user device are communicatively connected through a communications network. Clause (21) a user device of any clause mentioned in this paragraph comprising an input device configured to accept input, a memory device having executable code, a network communications device configured to communicate with a communications network, a display device, and a processor device being coupled to the input device, the network communications device, the display device, and to the memory device, the processor configured to execute the executable code stored in the memory device, the executable code configured to direct the processor to accept a clipping code associated with a content, request from a server a clipping associated with the clipping code, receive the clipping from the server, and display the clipping once the clipping is received from the server, and the clipping including a clipping content being pre-generated and a context integration data associated with the clipping. Clause (22) a server comprising a network communications device configured to communicate with a communications network and a memory device having executable code, a processor device being coupled to the network communications device and to the memory device, the processor configured to execute the executable code stored in the memory device, the executable code configured to direct the processor to accept a clipping code from a user device retrieve a clipping associated with the clipping code, and transmit the clipping to the user device, and the clipping including a clipping content being pre-generated and a context integration data associated with the clipping. Clause (23) a clipping creator comprising a network communications device configured to communicate with a communications network, an input device configured to accept input, a memory device having executable code, and a processor device being coupled to the input device, the network communications device, and to the memory device, the processor configured to execute the executable code stored in the memory device, the executable code configured to direct the processor to generate the clipping from the content, associate the clipping code with the clipping, transfer the clipping and the associated clipping code to the server, and to include a context integration data in the clipping.

Although the foregoing techniques have been described in some detail by way of illustration and example for purposes of clarity of understanding, it will be readily apparent to those of skill in the art in light of the teachings of this disclosure that changes and modifications may be made thereto without departing from the scope of the appended claims.

The foregoing has constituted a description of specific implementations showing how the aspects of the disclosure may be applied and put into use. These implementations are only exemplary. The aspects of this disclosure in their broadest and specific aspects is further defined in the claims which follow.

These claims and the language used therein are to be understood in terms of the variants that have been described. They are not to be restricted to such variants.

What is claimed is:

1. A method for a user device comprising:
accepting a clipping code associated with a content;
requesting from a server a clipping associated with the clipping code;
receiving the clipping from the server; and
displaying the clipping once the clipping is received from the server;
and the clipping including:
a pre-generated clipping content; and
a context integration data associated with the clipping.

2. The method of claim 1, further comprising:
adding the context integration data to the clipping.

3. The method of claim 1, further comprising:
using the context integration data in the clipping.

4. A method for a server comprising:
accepting a clipping code from a user device;
retrieving a clipping associated with the clipping code; and
transmitting the clipping to the user device, and the clipping including:
a pre-generated clipping content; and
a context integration data associated with the clipping.

5. The method of claim 4 further comprising:
tracking the context integration data associated with the clipping.

6. The method of claim 4 further comprising:
analyzing the context integration data associated with the clipping.

7. A method of claim 4, further comprising:
generating, using a clipping creator, the clipping, the clipping content, and the clipping code; and
transferring, from the clipping creator to the server, the clipping, the clipping content, and the clipping code so that the clipping can be retrieved by the server using the clipping code.

8. The method of claim 7, the step of generating further comprising
including the context integration data in the clipping.

9. The method of claim 1, wherein the clipping content includes the content.

10. A system for digitally clipping a content comprising:
a user device configured to accept a clipping code, transmit the clipping code to a server, and receive a clipping from the server; and
the server communicatively connected to the user device, the server configured to accept the clipping code from the user device, retrieve the clipping associated with the clipping code, and transmit the clipping associated with the clipping code to the user device.

11. The system of claim 10, the server further configured to track a context integration data associated with the clipping, and to store the tracked context integration data.

12. The system of claim 11, the server further configured to analyze the tracked context integration data.

13. The system of claim 11, the user device further configured to add the context integration data to the clipping.

14. The system of claim 11, the user device further configured to use the context integration data in the clipping.

15. The system of claim 10 further comprising:
a clipping creator configured to generate the clipping from the content, associate the clipping code with the clipping, and to transfer the clipping and the associated clipping code to the server.

16. The system of claim 15, the clipping creator further configured to include a context integration data in the clipping.

17. The system of claim 15, wherein the clipping creator is integrated with the server.

18. The system of claim 10, wherein the user device is any one of a computer, a mobile device, a computing device, a web browser, or a web browser extension.

19. The system of claim 10, wherein the server includes a data store for storing at least the clipping, the clipping code associated with the clipping, and a context integration data associated with the clipping.

20. The system of claim 10, wherein the server and user device are communicatively connected through a communications network.
